(19) United States
(12) Patent Application Publication
(10) Pub. No.: US 2016/0055993 A1
(43) Pub. Date: Feb. 25, 2016

(54) Method and Apparatus for Drawing Power From an Air Conditioning Disconnect Box

(71) Applicant: Sugar Tree Innovations LLC, Long Lane, MO (US)

(72) Inventor: James M. Salaki, Long Lane, MO (US)

(21) Appl. No.: 14/827,679

(22) Filed: Aug. 17, 2015

Related U.S. Application Data
(60) Provisional application No. 62/039,992, filed on Aug. 21, 2014.

(51) Int. Cl. H01H 21/22; H01H 11/00; H01R 43/16; H01R 13/73

(52) U.S. Cl. CPC H01H 21/22; H01R 13/73; H01H 11/00; H01R 43/16

(57) ABSTRACT

A pullout handle for an air conditioning disconnect (ACD) has contacts oriented to allow power to be conducted through air conditioning disconnect to an air conditioning unit when the pull-out handle is inserted in the ACD and power leads in electrical communication with the contacts.

### RELATED APPLICATION DATA

This application claims the benefit of provisional application Ser. No. 62/039,992 filed Aug. 21, 2014, currently pending, the disclosure of which is incorporated by reference herein.

### BACKGROUND AND SUMMARY

This disclosure relates to a method and apparatus for drawing power from an air conditioning disconnect to supply a local power supply panel. Generally speaking, the air conditioner disconnect (ACD) is located between a load center, for instance, a main distribution panel and an air conditioning unit. Although the description that follows refers to an air conditioning unit, it is intended that the term encompass equipment used for conditioning the atmosphere in a home or business, including heat pumps, cooling units, compressors, evaporators, cooling towers, etc. The ACD provides a local electrical circuit disconnection mechanism to allow a service person to perform maintenance on an air conditioning unit without opening a circuit breaker on the main distribution panel. In some models, the ACD has a switch to disconnect power from the main distribution panel to the air conditioning unit. In some models, the ACD has a pull-out type disconnect that allows power to be interrupted between the main distribution panel and the air conditioning unit. Some models have a combination of both schemes (handles and/or switches). In some models of ACDs with the pull-out handle, the pull-out handle comprises an on/off control, that is, two orientations in the ACD that align the contacts of the handle in either of two positions. In first position, the contacts may be aligned to provide power through the disconnect and close the circuit between the distribution panel and the air conditioning unit. In the second position, the handle may be inverted and the contacts may be positioned in the ACD to open the circuit and disconnect power from the distribution panel to the air conditioning unit.

The disclosure relates to a substitute pull-out handle for an ACD. The substitute pull-out handle has contacts that align in the first position to maintain power to the air conditioning unit. The contacts have leads which are directed to a local power distribution panel. The substitute handle may temporarily replace the ACD original on/off control pull-out handle to supply power from the ACD to a local power distribution panel at a local location adjacent to the ACD. The contacts of the substitute handle are arranged in the first position to maintain power to the air conditioning unit thereby maintaining the air conditioning unit running while power is being drawn from the ACD to the local power distribution panel.

### BRIEF DESCRIPTION OF THE DRAWINGS

FIG. 1 is a perspective view of an ACD with an on/off control pull-out handle installed therein;

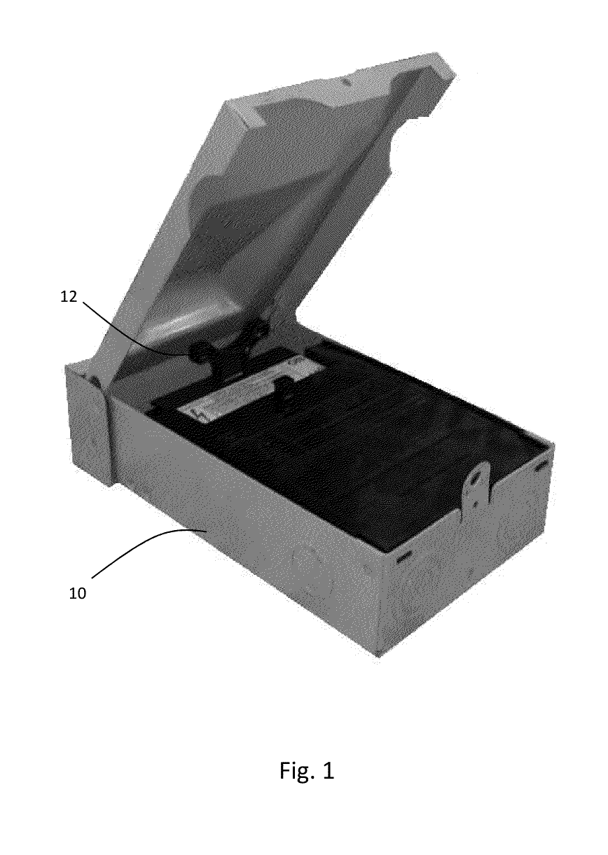

FIG. 2 is an ACD with the on/off control pull-out handle removed therefrom exposing the contacts of the ACD;

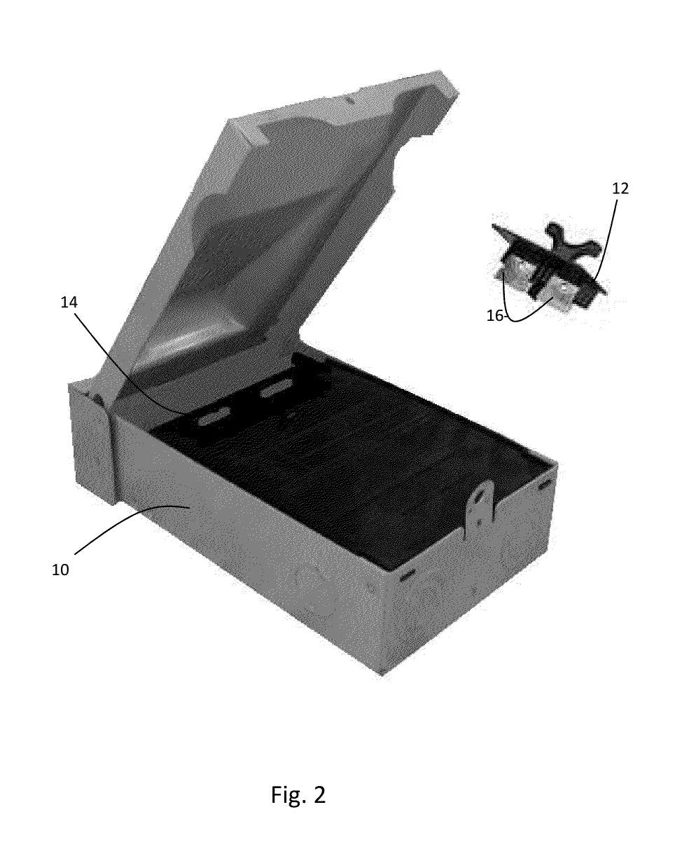

FIG. 3 shows both the on/off control handle removed from the ACD and a substitute power distribution handle;

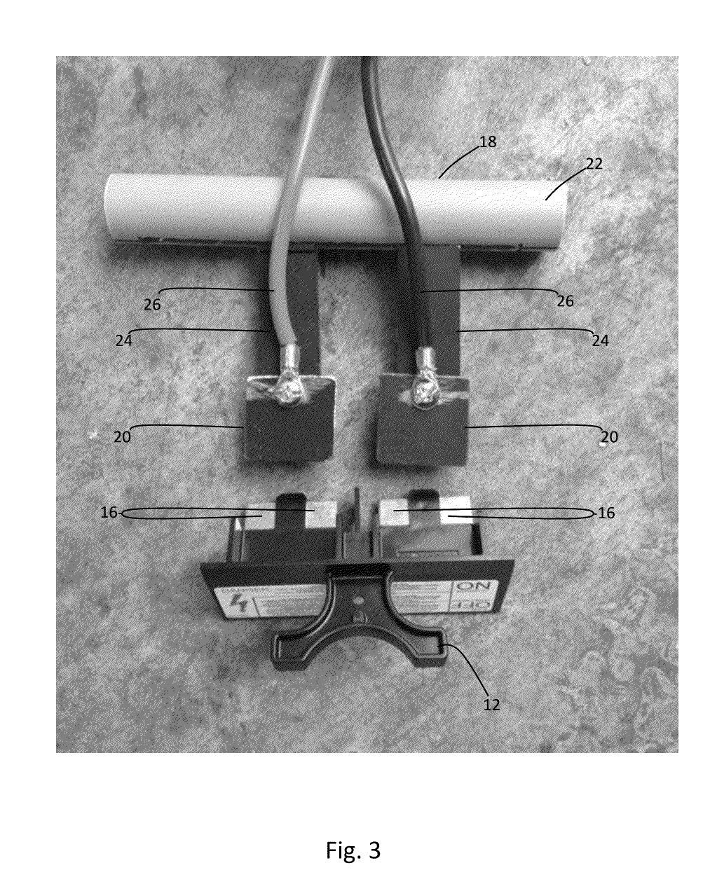

FIG. 4 shows the substitute power distribution handle of FIG. 3 inserted in the ACD;

FIG. 5 shows a further view of a power lead extending from the substitute power distribution handle inserted into the ACD; and

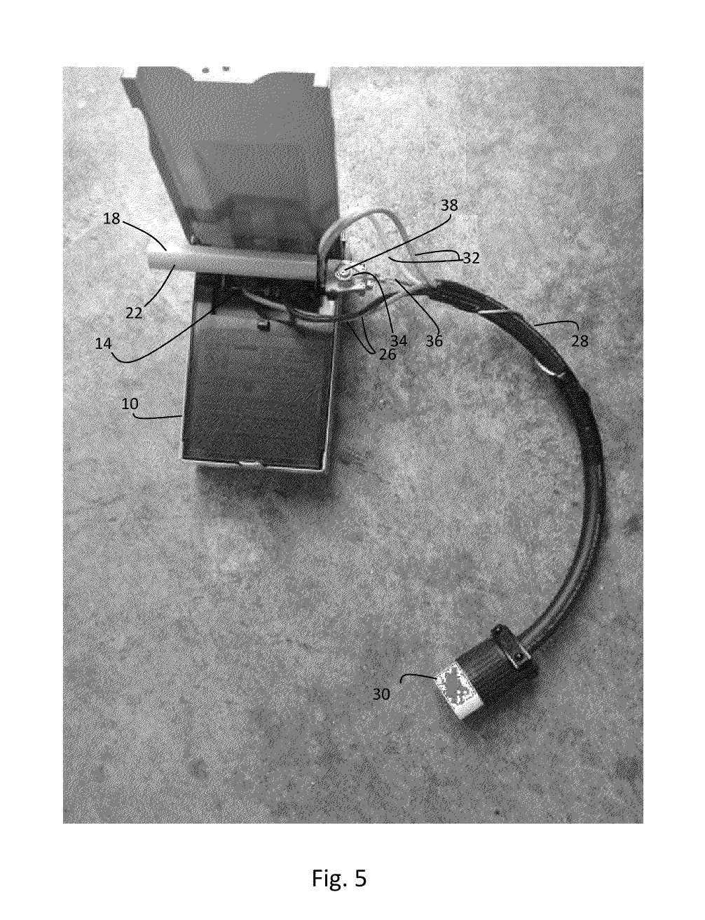

FIG. 6 shows the substitute power distribution handle inserted into the ACD and the power lead connected to a local power distribution panel.

### DETAILED DESCRIPTION

The ACD 10 may have an on/off control pull-out handle 12. The on/off control pull-out handle 12 is configured to be inserted in the ACD 10 and make contact with the contactors 14 of the ACD. The on/off control pull-out handle 12 may have two orientations in the ACD 10. In first position, contacts 16 of the on/off control pull-out handle 12 may be aligned with ACD contactors 14 to provide power through the disconnect and close the circuit between a distribution panel (not shown) and an air conditioning unit (not shown). In the second position, the on/off control pull-out handle may be inverted and the handle contacts 16 may be positioned in the ACD to not contact the ACD contactors 14 to open the circuit and disconnect power from the distribution panel to the air conditioning unit.

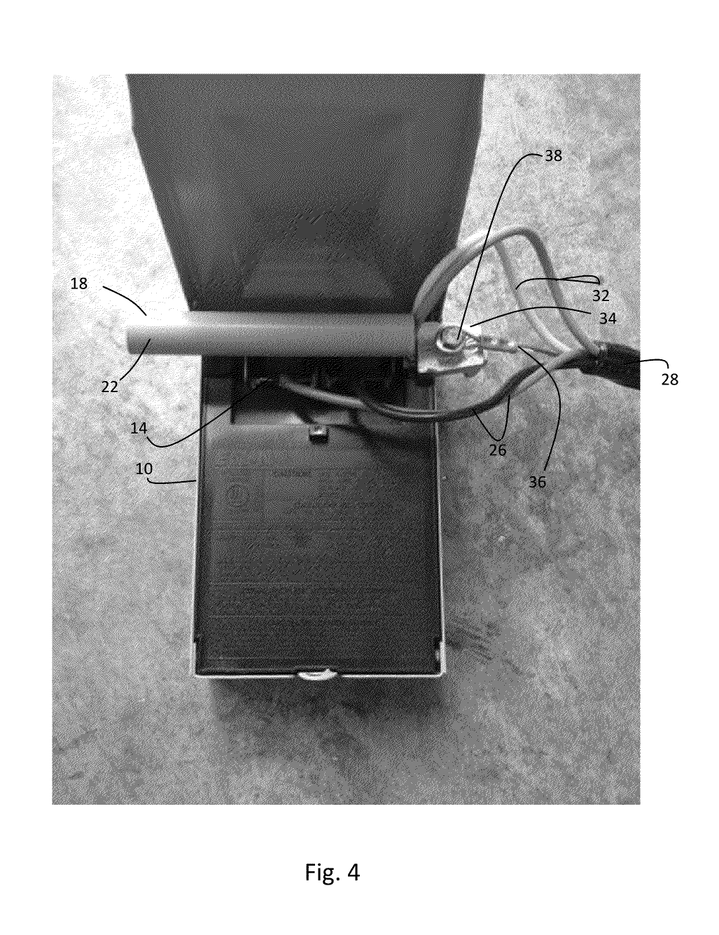

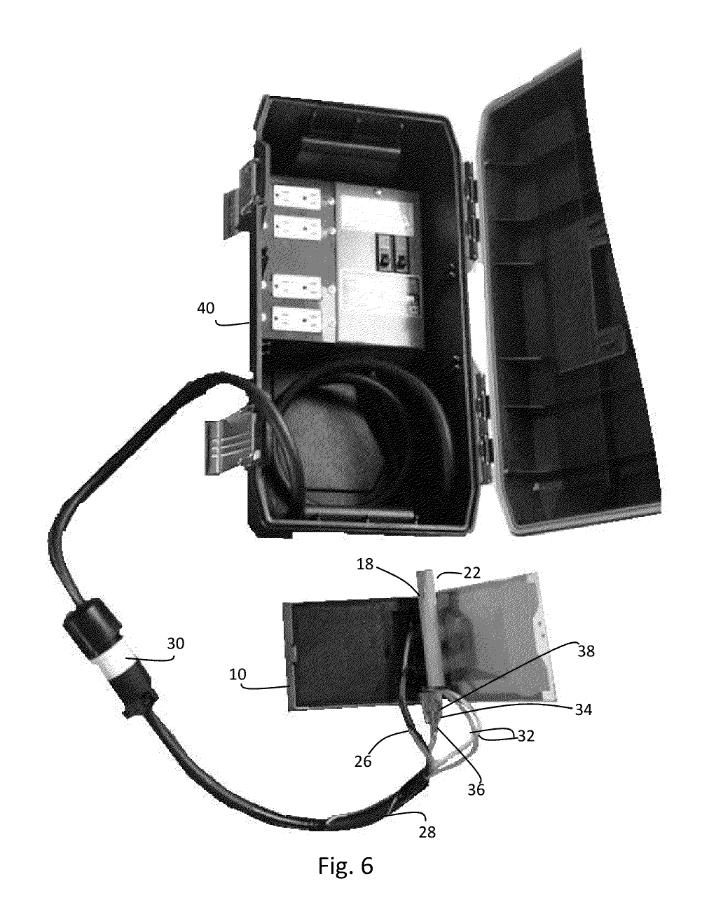

The substitute power distribution handle 18 may have contacts 20 that are configured to be inserted in the ACD in a manner that allows power to flow through the ACD to the air conditioning unit to maintain power to the air conditioning unit while local power is being drawn from the substitute power distribution handle. For instance, substitute power distribution handle 18 may have contacts 20 that have an orientation identical to the “on” position of the on/off control handle 12 of the ACD. The substitute power distribution handle 18 comprises an operator handle 22 with first and second extensions 24 and respective first and second contacts 20. The first and second contacts 20 extend from the extensions 24 and are positioned in such a way to interface with the contactors 14 of the ACD 10 to maintain power from the main distribution panel to the air conditioning unit. The contacts 20 of the substitute power distribution handle have leads 26 extending therefrom forming a cable 28 that leads to an outlet plug 30. The cable 28 extending to the outlet plug 30 includes ground wires 32. The ground wires 32 may be fixed to a clamp 34 on a frame of the ACD 10. The clamp 34 may be attached to the frame of the ACD 10 to penetrate through any paint on the frame of the ACD to provide a ground connection. Paint may be removed as necessary to make the ground connection. In addition to, or in the alternative to, a ground connection may be made to the main ground bar or rod. As shown in FIG. 4, the ground wires 32 extend from the cable 28 and attach to the clamp 34. The ground wires 32 may be attached to the clamp 34 with a screw connection or a lug (not shown) on a side of the clamp. The clamp 34 may further include a stress relief cable 36 which extends between a screw 38 on a top of the clamp 34 and the cable 28 to provide integrity for the cable as it is attached to the frame of the ACD 10. The power cable plug 30 may allow an electrical connection to a local power distribution panel 40 located local to the ACD. As shown in FIG. 6, the power distribution panel 40 comprises a unit with four two-plug outlets and circuit breakers to prevent overloading of the local power distribution panel.

In connecting the local power distribution panel 40 to the ACD 10, the power to the ACD may be disconnected by operating a switch (not shown) located at the ACD, or depending upon the style of the ACD, the on/off control handle 12 associated with the ACD may be removed. Once the on/off control handle 12 of the ACD is removed, the substitute power distribution handle 18 may be inserted into the ACD. The ground clamp 34 of the substitute power distribution handle 18 may be attached to the ACD frame. In the alternative, or in addition, to an alternate ground connection may be made by attaching a secondary grounding cable (not shown) from the grounding clamp to a grounded structure of a building or another ground connection. Once the ground connection has been made, the local distribution panel 40 may be plugged in to the cable plug 30 and power may be drawn to operate equipment from the local power distribution panel. When local operations are complete, the cable plug and the local power distribution panel may be disconnected. The substitute power distribution handle may be removed. The ground may be then disconnected and the on/off control pull-out handle associated with the ACD may be re-installed.

In accordance with an aspect of the disclosure, the substitute distribution handle 18 may be supplied in a kit together with a local power distribution panel 40 and/or an ACD. The ACD may also be supplied with a conventional pull-out handle 12. An operator may access the kit and be directed through instructions for removing the pull-out handle 12 of the ACD and inserting the substitute distribution handle 18 in the contactors 14 of the ACD, and connecting the power leads 26 of the substitute distribution handle to the local power distribution panel 40. The instructions may include text or other indicia directing use of the pull-out handle 12, ACD 10, substitute distribution handle 18, and local power distribution panel 40. The substitute distribution handle may be sold separately, in the kit, or distributed together with the local power distribution panel, and/or and ACD. The substitute distribution handle may be sold separately and provided with sufficient instructions directing the user to insert the substitute handle in the contactors of the ACD as described previously. In connection with the sale or distribution of the substitute handle, local power distribution panel, and/or ACD, the user (e.g., a purchaser of the substitute handle) is instructed that the purpose of the substitute distribution handle is to remove the pull-out handle, and install the substitute handle in the contactors of an ACD, and connect the power leads of the substitute handle to the local power distribution panel as described previously. Thus, the user is induced to replace, remove, and install the components as described previously.

In view of the foregoing, it will be seen that the several advantages are achieved and attained. The embodiments were chosen and described in order to best explain the principles and their practical application to thereby enable others skilled in the art to best utilize the various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A pullout handle for an air conditioning disconnect (ACD) comprising:
contacts oriented to allow power to be conducted through air conditioning disconnect to an air conditioning unit when the pull-out handle is inserted in the ACD; and
power leads in electrical communication with the contacts.

2. The handle of claim 1 further comprising a plug in electrical communication with the power leads.

3. The handle of claim 1 further comprising a ground connection.

4. The handle of claim 1 further comprising a clamp in electrical communication with the ground connection.

5. The handle of claim 4 wherein the clamp is configured to attach to the ACD.

6. The handle of claim 1 wherein the power leads comprise a cable.

7. The handle of claim 1 further comprising a local distribution panel configured to be in electrical communication with the power leads.

8. The handle of claim 1 further comprising a plug between the local distribution panel and the power leads.

9. A method comprising:
providing a pullout handle for an air conditioning disconnect (ACD) wherein the handle has contacts oriented to allow power to be conducted through air conditioning disconnect to an air conditioning unit and power leads in electrical communication with the contacts; and
inducing a user to remove the on/off control handle for the ACD and insert the pullout handle therein.

10. The method of claim 9 further comprising inducing the user to place a local distribution panel in electrical communication with the power leads.

11. The method of claim 10 wherein the step of inducing the user to place a local distribution panel in electrical communication with the power leads includes connecting a plug between the local distribution panel and the power leads.

12. The method of claim 9 further comprising inducing the user to make a ground connection for the pullout handle.

13. The method of claim 12 wherein the step of inducing the user to make a ground connection comprises installing a clamp on the ACD.

14. A method comprising:
accessing a pullout handle for an air conditioning disconnect (ACD) having contacts oriented to allow power to be conducted through air conditioning disconnect to an air conditioning unit, and power leads in electrical communication with the contacts;
removing the on/off control handle of the ACD; and
installing the pullout handle in the ACD.

15. The method of claim 14 further comprising placing a local distribution panel in electrical communication with the power leads.

16. The method of claim 14 wherein the step of placing a local distribution panel in electrical communication with the power leads includes connecting a plug between the local distribution panel and the power leads.

17. The method of claim 14 further comprising making a ground connection for the pullout handle.

18. The method of claim 17 wherein the step of making a ground connection for the pull-out handle comprises installing a clamp on the ACD.

19. A combination comprising:
a pullout handle for an air conditioning disconnect (ACD) with contacts oriented to allow power to be conducted through air conditioning disconnect to an air conditioning unit when the pull-out handle is inserted in the ACD, and power leads in electrical communication with the contacts; and
a local distribution panel configured to be removably connectable with the power leads.

20. The combination of claim 19 further comprising an ACD.
